(19) United States
(12) Patent Application Publication
(10) Pub. No.: US 2008/0222271 A1
(43) Pub. Date: Sep. 11, 2008

(54) Age-restricted website service with parental notification

(76) Inventor: Cary Spires, Oxon Hill, MD (US)

Correspondence Address: DEAN A. CRAINE;SUITE 140, 400 - 112TH AVENUE NE, BELLEVUE, WA, 98004, US

(21) Appl. No.: 12/012,841

(22) Filed: Feb. 5, 2008

Related U.S. Application Data
(60) Provisional application No. 60/905,249, filed on Mar. 5, 2007.

(51) Int. Cl. G06F 15/16

(52) U.S. Cl. 709/218

(57) ABSTRACT

An age-restricted website service accessed only by a proprietary browser software program operated by an authorized child or teenager. When loaded into the user's computer, an icon is loaded onto the desktop and all other browser icons are removed. When activated, the browser program only connects to the service's host computer. The service provides access to an interactive network of web forums, photos, blogs, chats and logs and emails safe for small children. During setup, a signup menu is displayed that includes a plurality of questions completed by the new member requesting information regarding the name of the member, the age of the member, name of the member's parent or guardian, the mailing address of the parent or guardian, the telephone number and email address of the member's parent or guardian. After the menu questionnaire is completed and submitted, the member's parent or guardian is then contacted by U.S. Postal Restricted Receipt service requiring a signature and positive identification. The representative may also send the parent or guardian an email confirming that the account for the new member has been authorized. Once the account has been authorized verbally and via email the chosen user name and temporary password for the new member is mailed to the parent or guardian. The age of the member is limited to 7 to 17 years. Also, the passwords are all members are changed annually.

This is a utility patent application which claims benefit of U.S. Provisional Application No. 60/905,249 filed on Mar. 5, 2007.

### BACKGROUND OF THE INVENTION

1. Field of the Invention

This invention relates to parental security systems for children who use the Internet, and more particularly to such systems that require pre-approval by a parent before the child can create an account on a specific website.

2. Description of the Related Art

The Internet has become an important information and entertainment resource for adults, teenagers and children. Unfortunately, the Internet has become a valuable resource for aggressive marketing companies who attempt to offer and sell products or services to on-line customers and sexual predators. Aggressive sales tactics applied to certain groups of on-line customers, such as children and teenagers, often leads to impulsive purchases and dangerous activities. Parents of children and teenagers are especially concerned with this issue.

Another problem associated with the Internet is that information can be freely exchanged between strangers. Many websites require new users create an account that uses unique account name (often an email address) and a unique password. Once the account is created, the user is able to create a personal profile, upload photographs, send emails or instant messaging messages, and blog and share comments with other users signed up on the website.

In many families, young teenagers and children are often left alone with unlimited access to a computer connected to the Internet. Many parents of these children and teenagers are concerned that they may visit websites or chat rooms inappropriate for their ages. A major concern is making contact and share personal information with child predators.

Child predators who use the Internet usually disguise their real DNS names and ages. Tracking down the real names and addresses of child predators is very difficult.

What is needed is a website service that provides exclusive connection to the Internet and is specifically designed for children and teenagers that limits the users to a specific age range, and then sends a notification to the parent's or guardian's physical address with a signature receipt, along with the chosen user's name and temporary password. Its also necessary to positively identify every user.

### SUMMARY OF THE INVENTION

It is an object of the present invention to provide a website service that provides an exclusive browser software program that only allows the user to visit an age restricted website provided by the website service.

It is an object of the present invention to provide a website service specifically designed for children and teenagers that only allows users of a specific age range to join.

It is a further object of the present invention to provide such a website service which obtains permission of the parent or guardian of the child or teenager requesting before granting access.

It is a further object of the present invention to provide such a website service that used multiple methods of obtaining parental or guardian authorization.

These and other objects of the invention are met by the website service specifically designed for children (7 to 12 years of age) and teenagers (13 to 17 years of age) that requires members to create an account on the website service. The system includes a proprietary browser software program that communicates with a host software program loaded into the memory of a web server controlled and operated by the website service provider. When the proprietary browser software program is loaded into the user's computer, all other web browsers are disabled.

When a user signs up for the website service, an Internet-related software suite is downloaded from the web server and into the user's computer. Besides the proprietary browser software program, the software suite also includes an email client, a download manager, and an Internet relay chat. When loaded into the user's computer, a specific icon for the proprietary browser is created on the desktop and all other icons are removed. When the proprietary browser software program is activated, it automatically connects the user to the service's web server.

The users of the web service are restricted according to age so that it only registered members within a specific age range may join the server 10. When a new member 12 attempts to create an account on the website, the user must input his or her age, name, parental or guardian name, email address, telephone numbers, and physical mailing address. If the user's age meets the service's age range limitation, a website representative contacts the applicant's parent or guardian via a telephone call or via email. Once the confirmation has been received, the representative then sends the new user's parent or guardian a postal card by Restricted Delivery with a signature request and may require date of birth verification. It is important that the parent and guardian be verified, because the postal card contains the new member's user name and temporary password. The parent and guardian are responsible for giving the user name and temporary password to the new member.

An important feature of the service is the use of the proprietary browser that prevents the user from using the computer to contact other websites not authorized by the user's parent or guardian. Also, because the service is restricted to members within the specific age range, very young children and individuals 18 years or older are precluded from setting up an account and contacting member users. Use of registered certified U.S. mailing with signature receipt and date of birth verification of the new member's parent and guardian, prevents fraudulent users from using the service and creates a positive identifiable name and physical mailing address for the user's parent or guardian which then can be used to identify and contact the user if improper activity occurs. For additional security, parental authorization steps may be repeated annually to renew the account information and all passwords. When a member reaches 18 years of age, the user's account is automatically closed.

For additional security, a service representative may check the names of members and parents or guardians with local and national missing children lists and sex offender lists, respectively.

### DESCRIPTION OF THE DRAWINGS

FIG. 1 is a diagram of the age-restricted website service disclosed herein.

FIG. 2 is a front view of a Return Receipt filled out to be returned to the service provider.

FIG. 3 is a rear view of the Return Receipt filled out to be sent to the new member's parents or guardian with the requirement that proof of identification be provided before delivering Receipt.

FIG. 4 is an illustration of a Member Contact List.

FIG. 5 is a flow diagram showing the steps followed when a new member signs up for the service

### DESCRIPTION OF THE PREFERRED EMBODIMENT(S)

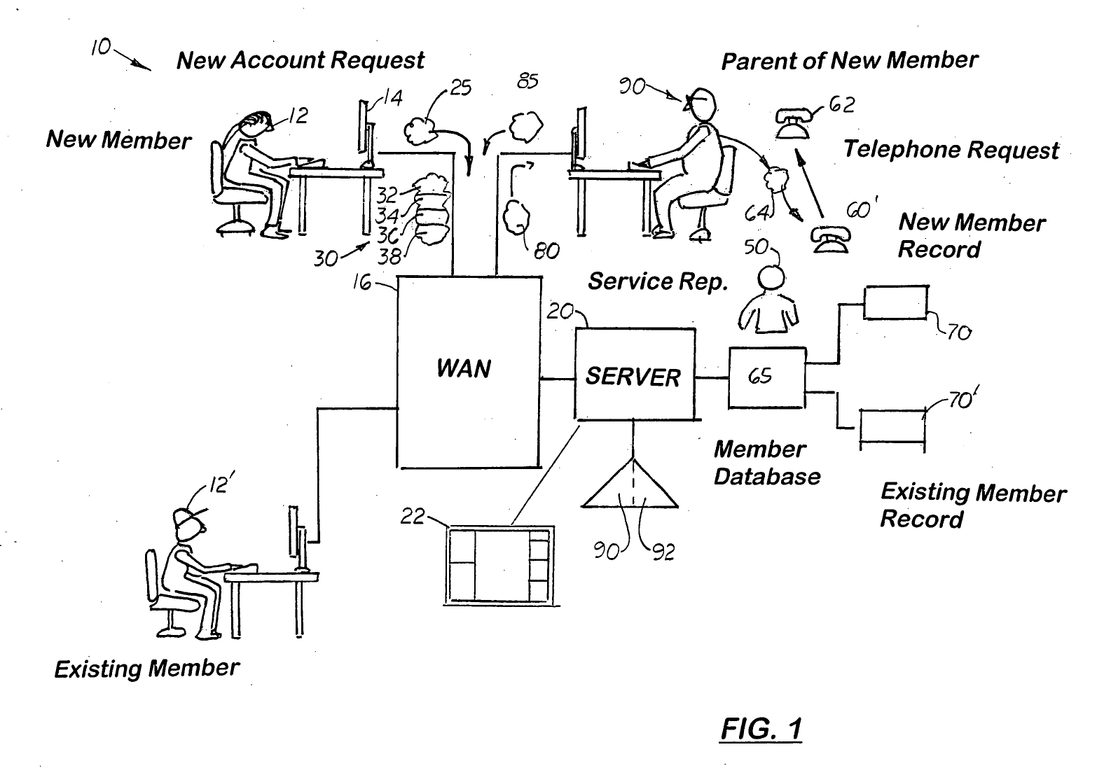

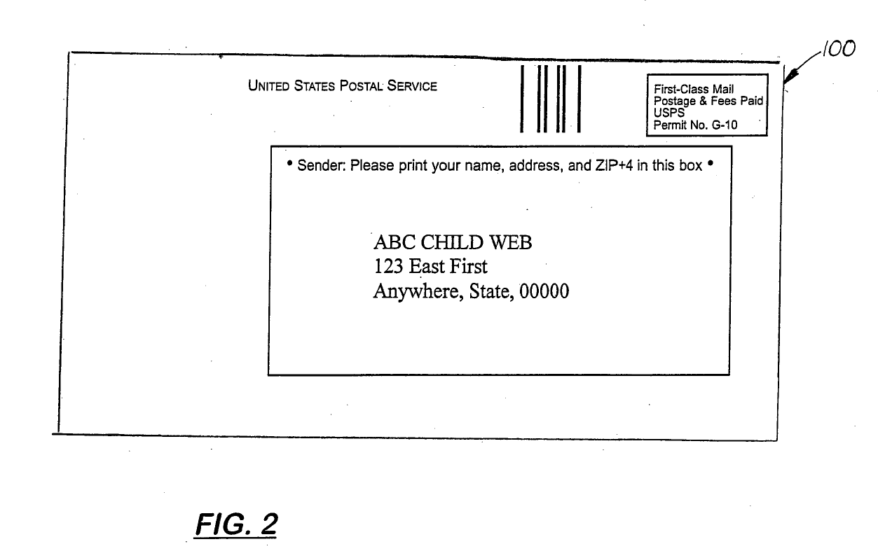

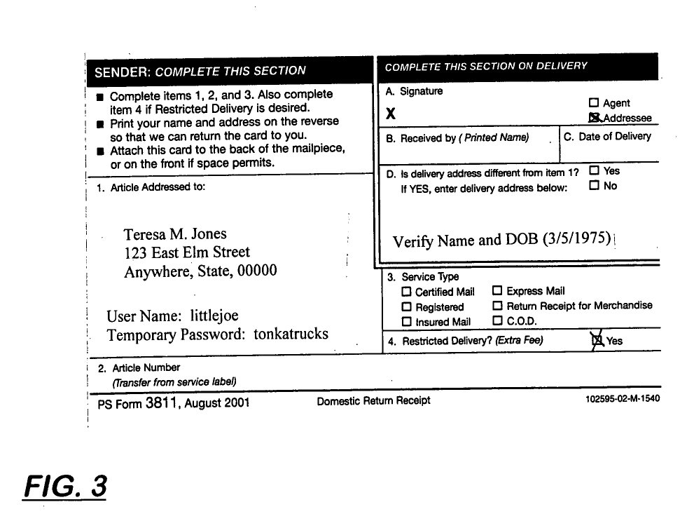

Referring to the accompanying FIGS. 1-5, there is described an age-restricted website service 10 for children and teenagers that require permission from the child's parent or guardian before an account 70, 70′ with the service 10 is created.

The service 10 includes a proprietary browser software program that communicates with web server 20 connected to a wide area network 16 which is controlled and operated by the service company. When a new member 12 signs up for the service 10, an Internet-related software suite 30 is downloaded from the server 20 into the user's computer 14. The software suite 30 includes the proprietary web browser 32 an email client 34, a download manager 36, and an Internet relay chat 38. When loaded into the computer, the browser 32 becomes the only browser software program on the new user's desk top. When the browser 32 is activated by the new member 12, it automatically connects the new member 12 to the service's server 20. The new member 12 is not allowed to use the Internet, exchange emails or participate in chat until the account has been authorized and the user name and temporary password has been issued.

The new member 12 of the service 10 is restricted according to age. When a new member 12 tries to create an account on the server 20, the new member 12 must meet the service's age limitation. If the age limitation is met, a website representative 50 automatically contacts the new member's parent or guardian via several communication avenues to inform him or her that their child wants to create a member account with the service 10.

When submitting an application to set-up a new member account, a new member 12 completes a form 25 which is then transmitted to the server 20 and examined by the website representative 50. The website representative 50 examines the information contained in the form 25 to determine if the new member's meets the 7 to 17 years of age limitation requirement of the service 10. If the age limitation requirement is met, the website representative 50 automatically checks the applicant's name against a list of national or local missing children. The representative also checks the applicant's parent's or guardian's name against a list of convicted child molesters or predators. If no hits are found, the representative 50 then contacts the new member's parent or guardian 90 via a telephone 60, 60′ and requests verbal authorization 64 to create a new account for the new member 12. Alternatively, the representative 50 may contact the parent or guardian via email. In some jurisdictions, the convicted child molesters or predators list is checked only after receiving permission from the new member's parent or guardian.

To ensure that the person authorizing creation of the new account is the new member's parent or guardian, the representative 50 then sends a U.S. Postal Service Restricted Return Receipt 100 to the name and address of the parent or guardian submitted by the new member 12. The Restricted Return Receipt 100 includes a signature line 102 which requires that the parent or guardian sign and verify his or her date of birth before the U.S. Postal worker hands over the Receipt to the recipient. Printed on or accompanying the Receipt 100 is the new member's user's name 86 and temporary password 88. The parent or guardian 90 is then responsible for giving the user name 86 and temporary password 88 to the new member 12.

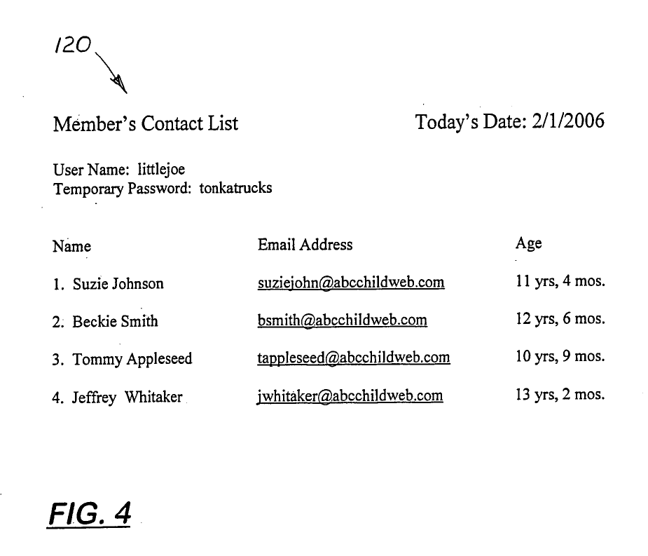

Each new member 12 account has a secondary account 130 assigned to the new member's parent or guardian 90 The secondary account 130 enables the parent or guardian 90 of the new member 12 to review the content of the member record 70 at any time and revoke authorization for the account at any time. Once the member record 70 is created, the new member 12 is able to interact with any existing member 12′ who also has member record 70′ on the member database 65. By providing a secondary account to the new member's parent or guardian, a contact member list 120 for the new member 12, shown in FIG. 4, may be generated and inspected by the new member's parent or guardian 90.

For additional protection, the service 10 could require the parent or guardian 90 to approve new contacts to the member's contact list 120. Each time a new contact is requested, an email notification 80 may be sent to the parent or guardian 90 notifying him or her that a new contact is being added to their child's Contact list 120. The parent or guardian 90 would then be able contact the service 10 requesting that the new contact be allowed or removed from the Contact list 120.

Because the website service 10 is restricted to members in age from 7 to 17, very young children and persons over the age of 17 are precluded from setting up an account. When a member 12 exceeds 17 years of age, the account is automatically closed. For additional security, parental authorization may be required annually to renew the account and all passwords for the members may be changed annually.

For additional security, parental authorization steps may be repeated annually to renew the account information and all passwords. When a member reaches 17 years of age, the user's account is automatically closed.

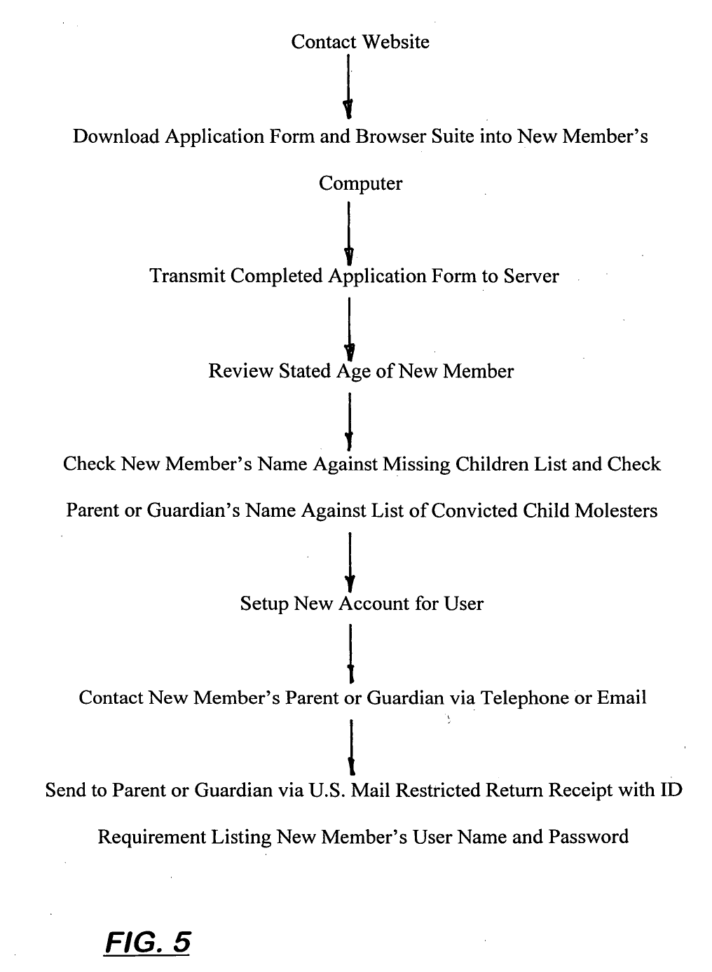

FIG. 5 is a flow diagram depicting the above referenced steps for signing up a new member 12.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. An age-restricted website service, comprising:
a. a wide area computer network;
b. a server connected to said wide area computer network, said server including a host side program capable of communicating with a proprietary browser program on a remote computer;
c. a plurality of remotes computer each including a desktop display and with a proprietary browser program capable of connecting and communicating with said server, said browser program creating an icon on said desktop display and removes all existing browser programs from the desktop of said remote computer; and,
d. a plurality of membership data files located on said server, each said membership data file containing the name of a user between the ages of 7 and 17, the name of the parent or guardian of the user, the telephone number of the parent or guardian of the user and the email address of the parent or guardian, and the physical mailing address of the parent or guardian.

2. A method for preventing contact with a minor child over a computer connected to a wide area network, comprising the following steps:
a. selecting a server connected to a wide area computer network;
b. installing an age-restricted hosting program into said server, said hosting program being linked to a membership data file containing the personal information of authorized users between a selected age range between 7 and 17 years of age, and the parental or guardian contact information fore each user;
c. installing a client side proprietary browser software program into a remote computer capable of connecting to said wide area computer network, said browser software program includes a signup module in which a user enters his or her name, age, email, parent or guardian name, email address, telephone number, and mailing address which are then transmitted to said server;
d. reviewing the age information of said user to determine if the age of the user is within the selected age range listed in the hosting program; and,
e. contacting the parent or guardian of the user via a U.S. Postal Restriction Receipt to verify and obtain signature of the parent or guardian authorizing the new user to connect to said server.
